(19) United States
(12) Patent Application Publication
(10) Pub. No.: US 2024/0300568 A1
(43) Pub. Date: Sep. 12, 2024

(54) HANDWHEEL ACTUATOR FOR STEERING SYSTEM

(71) Applicant: Schaeffler Technologies AG & Co. KG, Herzogenaurach (DE)

(72) Inventors: Nicholas Hrusch, Wooster, OH (US); Todd Sturgin, Wooster, OH (US)

(73) Assignee: Schaeffler Technologies AG & Co. KG, Herzogenaurach (DE)

(21) Appl. No.: 18/585,237

(22) Filed: Feb. 23, 2024

Related U.S. Application Data
(60) Provisional application No. 63/451,305, filed on Mar. 10, 2023.

(51) Int. Cl. B62D 5/00; G05G 5/05

(52) U.S. Cl. CPC B62D 5/005; G05G 5/05; G05G 2505/00

(57) ABSTRACT

A handwheel actuator for a steering system includes a stator, a shaft, and a rotor. The shaft is disposed within the stator and configured to be rotatably driven by a handwheel. The rotor is rotatably driven by the shaft. The rotor and the stator form a first fluid chamber and a second fluid chamber. Rotation of the rotor is configured to displace from the first chamber to the second chamber so as to apply a rotational resistance to the shaft.

### CROSS-REFERENCE TO RELATED APPLICATIONS

This application claims priority to U.S. Provisional Application No. 63/451,305 filed Mar. 10, 2023, the entire disclosure of which is incorporated by reference herein.

### TECHNICAL FIELD

This disclosure is generally related to a handwheel actuator for a drive-by-wire steering system.

### BACKGROUND

In a drive-by-wire application, a handwheel has no natural force feedback for a driver, and so without an additional mechanism or software, the driver input may feel unnatural depending on the driving condition compared to a convention steering system.

### SUMMARY

An example embodiment of a handwheel actuator for a steering system is provided that includes a housing, a shaft disposed within the housing, and a rotary damper rotatably driven by the shaft about a rotational axis. The shaft is rotatably driven by the handwheel. The rotary damper and the housing form a first fluid chamber and a second fluid chamber. Rotation of the rotary damper in a first direction is configured to displace a fluid from the first fluid chamber to the second fluid chamber so as to apply a rotational resistance to the shaft. Rotation of the rotary damper in a second direction is configured to displace a fluid from the second fluid chamber to the first fluid chamber so as to apply a rotational resistance to the shaft.

In an example embodiment, the handwheel actuator further comprises a metered fluid passage arranged in the housing. In a further aspect, the metered fluid passage is electronically metered.

In an example embodiment, a fluid flow resistance of the metered fluid passage is controlled via an electronic fluid control valve.

In an example embodiment, the rotational resistance can be varied based on vehicle speed.

In an example embodiment, the first and second fluid chambers are ring-shaped.

In an example embodiment, rotary movement of the rotary damper is configured to move the fluid about the rotational axis.

In an example embodiment, the shaft is configured to be rotatably driven by the handwheel about the rotational axis of the rotary damper.

In an example embodiment, the first fluid chamber is sealingly separated from the second fluid chamber via the rotary damper.

In an example embodiment, a rotational range of the shaft is greater than a rotational range of the rotary damper.

In an example embodiment, the steering system includes a reduction arranged within the housing. The reduction can be a planetary gearset. The reduction can also be arranged between the shaft and the rotary damper such that the shaft drives the reduction and the reduction drives the rotary damper.

An example embodiment of a handwheel actuator for a steering system is provided that includes a housing, a rotary damper driven by a handwheel, and a metered fluid passage. The rotary damper and the housing define a first fluid chamber and a second fluid chamber which are fluidly connected to each other via the metered fluid passage. The first fluid chamber, the second fluid chamber, and the metered fluid passage define a variable resistance closed fluid system arranged within the housing. Rotation of the rotary damper causes displacement of a fluid within the variable resistance closed fluid system, that, in effect, applies a rotational resistance to the rotary damper.

In an example embodiment, the first fluid chamber is defined by a first side of the rotary damper and the housing, and the second fluid chamber is defined by a second side of the rotary damper and the housing.

In an example embodiment, the handwheel actuator includes a shaft disposed within the housing, and the shaft is drivably connected to the rotary damper.

An example embodiment of a handwheel actuator for a steering system is provided that includes a housing and a rotary damper driven by a handwheel. Rotation of the rotary damper causes an exchange of fluid between the first fluid chamber and the second fluid chamber, which, in effect, applies a rotational resistance to the rotary damper.

In an example embodiment, the handwheel actuator includes a metered fluid passage arranged between the first fluid chamber and the second fluid chamber, and a flow area of the metered fluid passage is electronically variable so as to vary the rotational resistance.

In an example embodiment, the handwheel actuator includes at least one spring that is disposed within the housing that returns the handwheel to a non-turning position.

### BRIEF DESCRIPTION OF THE DRAWINGS

The foregoing Summary will be best understood when read in conjunction with the appended drawings. In the drawings:

FIG. 1 shows a perspective view of an example embodiment of a handwheel actuator together with a handwheel.

FIG. 2 shows a perspective view of the handwheel actuator of FIG. 1.

FIG. 3 shows a cross-sectional view of the handwheel actuator and handwheel taken from FIG. 1.

FIG. 4 shows an exploded perspective view of the handwheel actuator of FIG. 1.

FIG. 5 shows an exploded perspective view of a portion of the handwheel actuator of FIG. 1.

FIG. 6A shows a perspective view of the portion of the handwheel actuator shown in FIG. 5.

FIG. 6B shows a perspective view of the portion of the handwheel actuator shown in FIG. 5.

FIG. 7 shows an exploded perspective view of an example embodiment of a rotary damper and corresponding seals.

FIG. 8 shows an exploded perspective view of an example embodiment of a housing and sealing components of the housing.

FIG. 9A shows perspective view of an assembly of the housing and sealing components shown in FIG. 8.

FIG. 9B shows a perspective view of an assembly of the housing and sealing components shown in FIG. 8.

FIG. 10A shows an exploded perspective view of an example embodiment of a rear cover and a rolling element bearing for the handwheel actuator of FIG. 1.

FIG. 10B shows a perspective view of an assembly of the rolling element bearing and rear cover of FIG. 10A.

FIG. 11 shows a perspective view of an example embodiment of an electronic fluid control valve for the handwheel actuator of FIG. 1.

FIG. 12A shows a cross-sectional view of the electronic fluid control valve taken from FIG. 11 with the electronic fluid control valve in a first flow state.

FIG. 12B shows a cross-sectional view of the electronic fluid control valve taken from FIG. 11 with the electronic fluid control valve in a second flow state.

FIG. 12C shows a cross-sectional view of the electronic fluid control valve taken from FIG. 11 with the electronic fluid control valve in a third flow state.

FIG. 13 shows a perspective view of an example embodiment of a planetary carrier for the handwheel actuator of FIG. 1.

FIG. 14 shows an exploded perspective view of the planetary carrier of FIG. 13.

FIG. 15 shows an exploded perspective view of an example embodiment of an input shaft and driver pins for the handwheel actuator of FIG. 1.

FIG. 16 shows an exploded perspective view of an example embodiment of a front cover and a rolling element bearing for the handwheel actuator of FIG. 1.

FIG. 17 shows an end view of the handwheel actuator of FIG. 2 without the front cover installed.

FIG. 18A shows a cross-sectional view of the handwheel actuator taken from FIG. 1 with the rotary damper at a first rotational position.

FIG. 18B shows a cross-sectional view of the handwheel actuator taken from FIG. 1 with the rotary damper at a second rotational position.

FIG. 18C shows a cross-sectional view of the handwheel actuator taken from FIG. 1 with the rotary damper at a third rotational position.

FIG. 19 shows a schematic representation of a drive-by-wire steering system of a vehicle.

### DETAILED DESCRIPTION

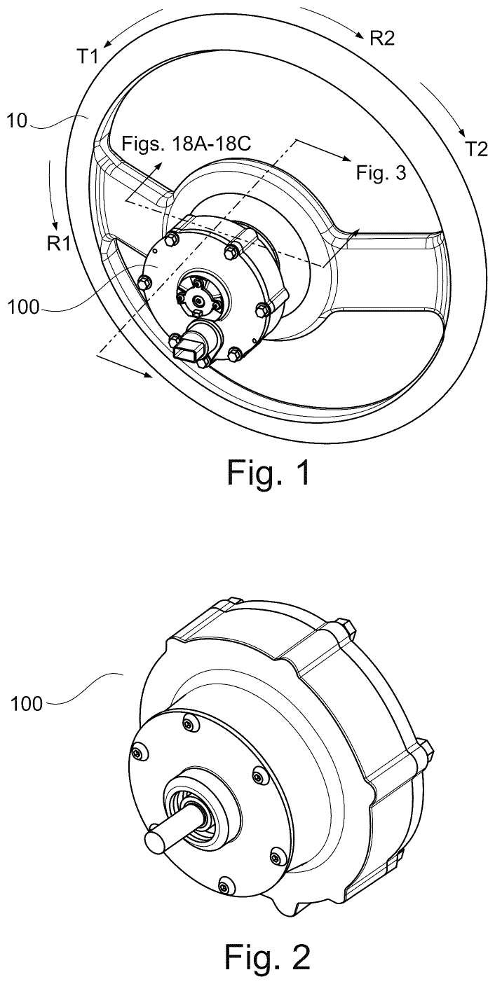

FIG. 1 shows a perspective view of an example embodiment of a handwheel actuator 100 together with a handwheel 10, often referred to as a steering wheel. FIG. 2 shows a perspective view of the handwheel actuator 100.

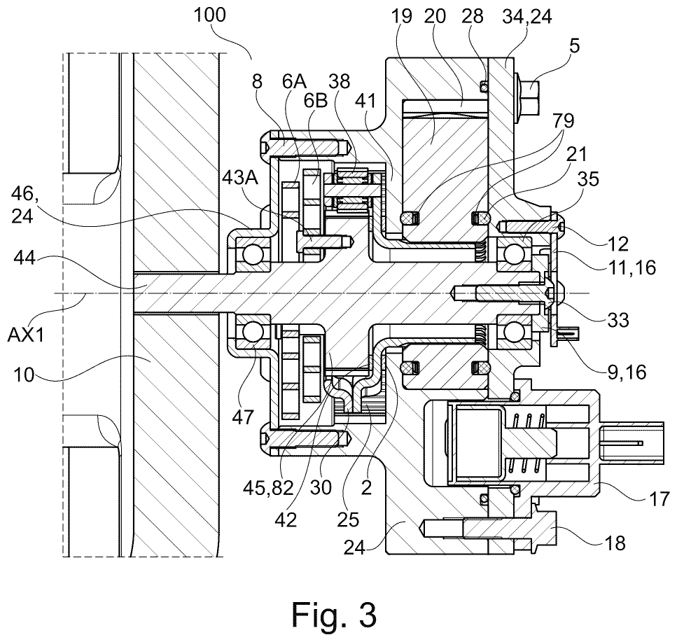

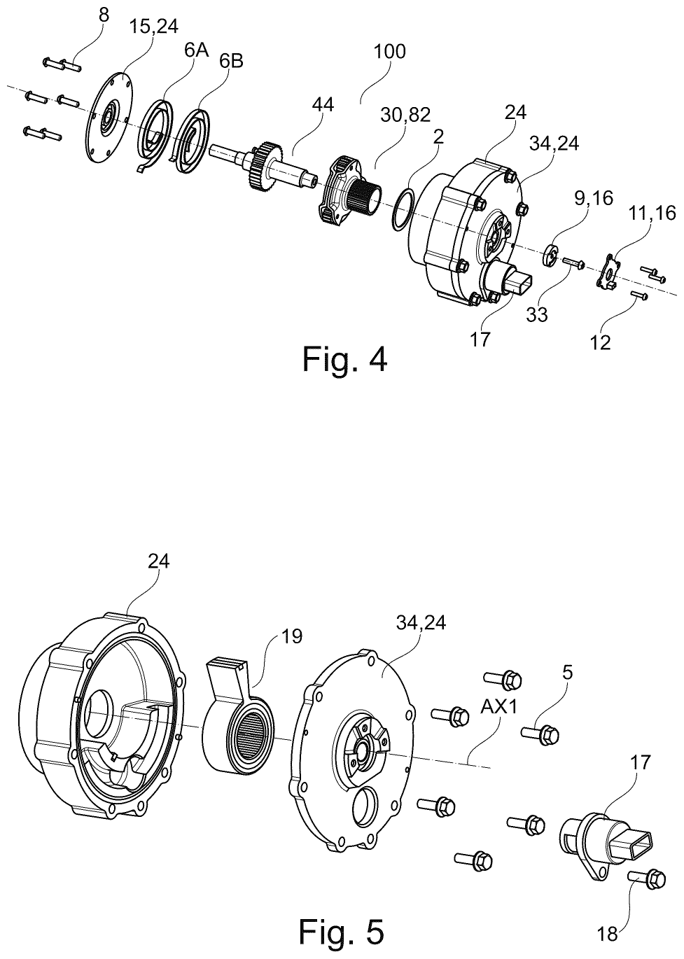

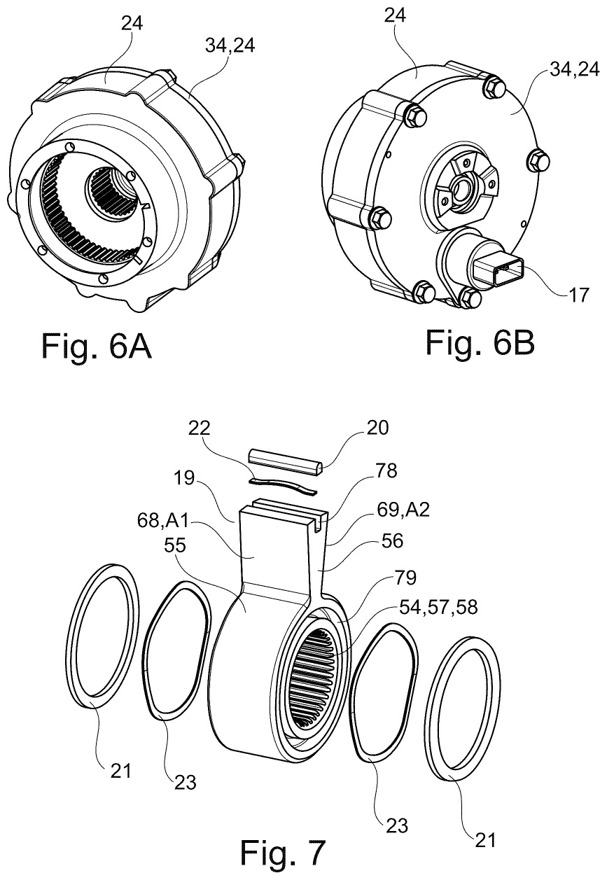

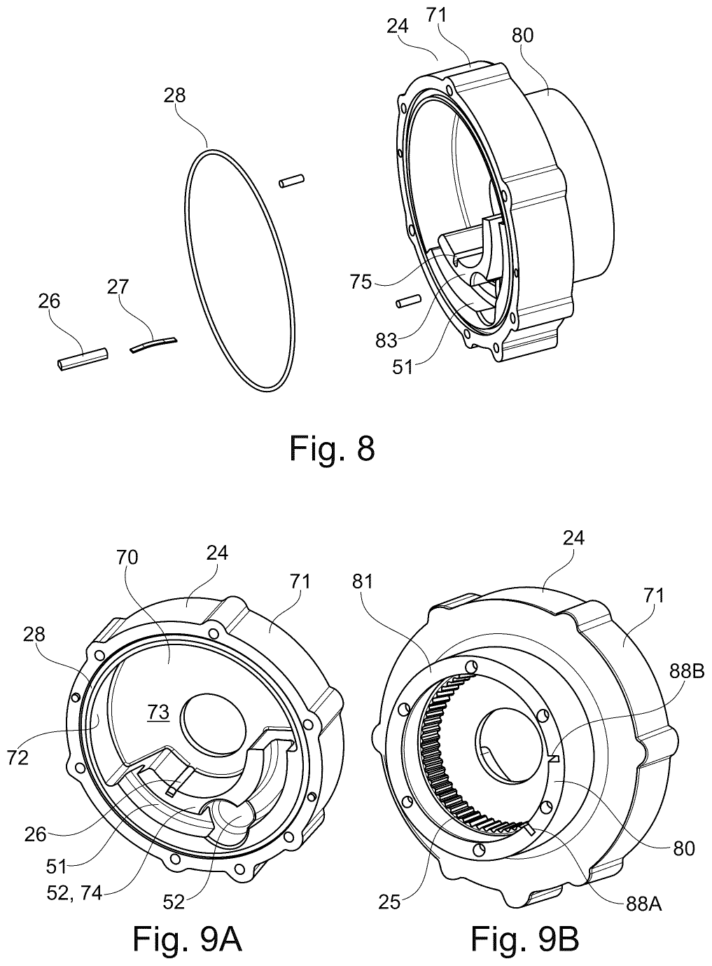

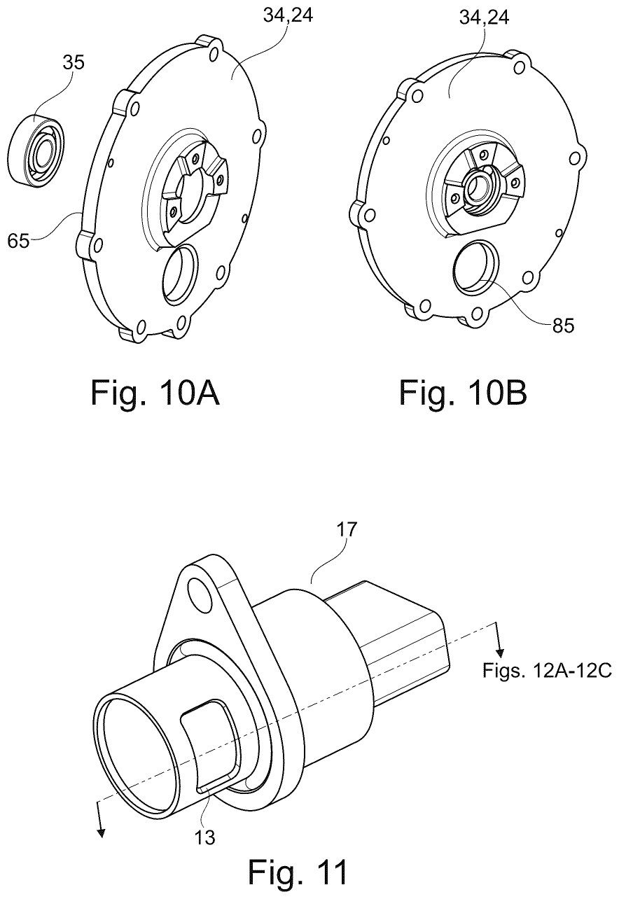

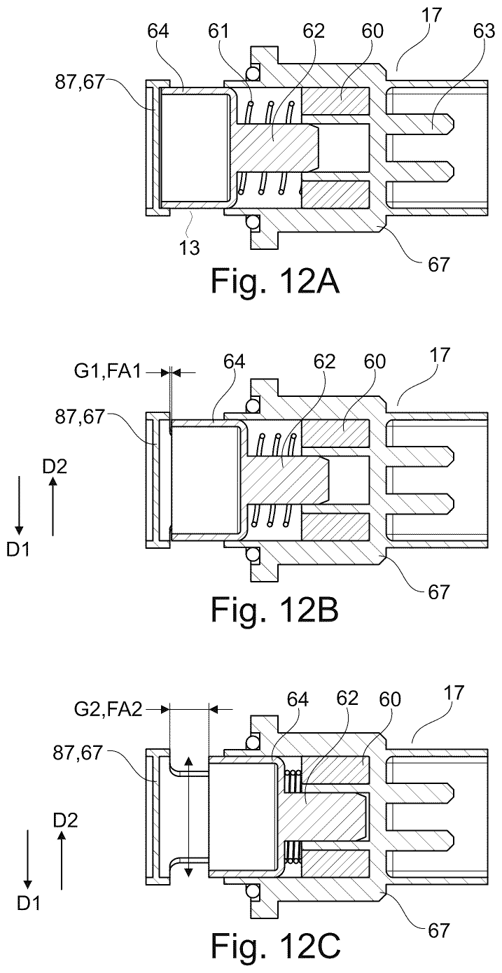

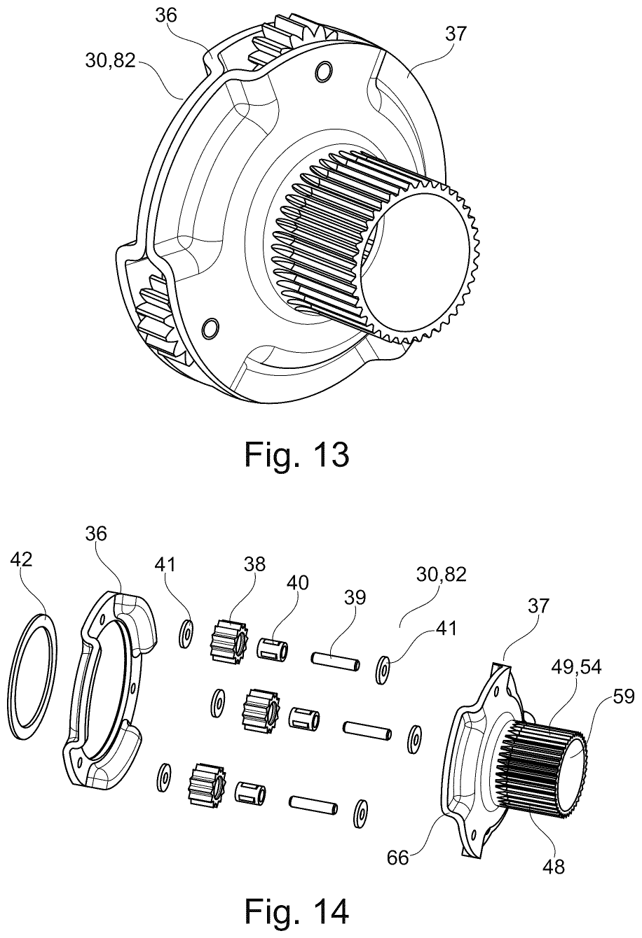

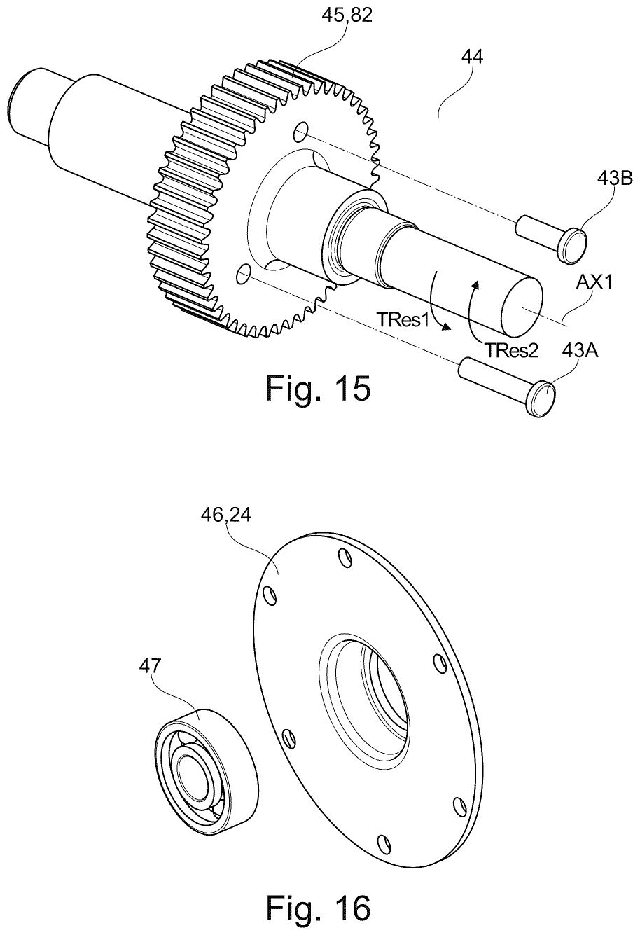

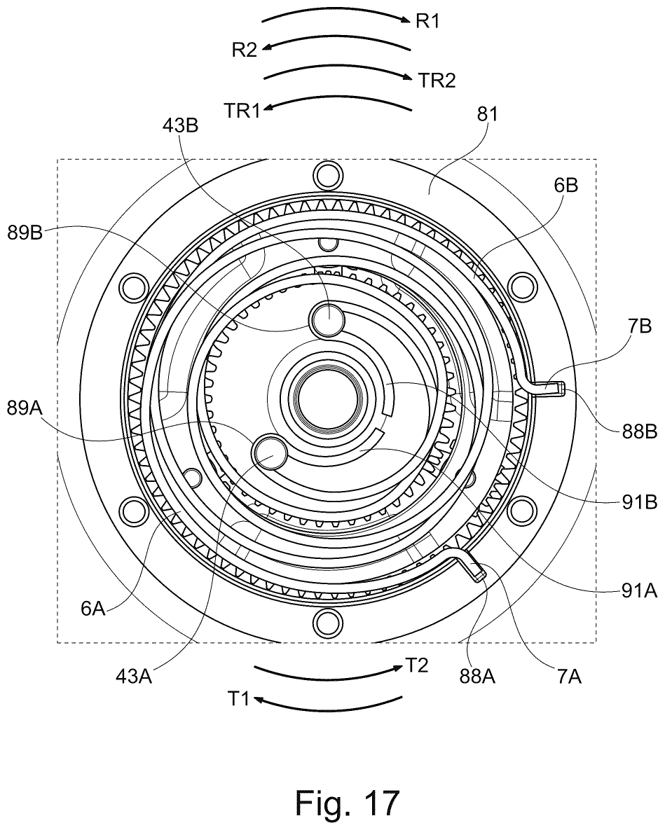

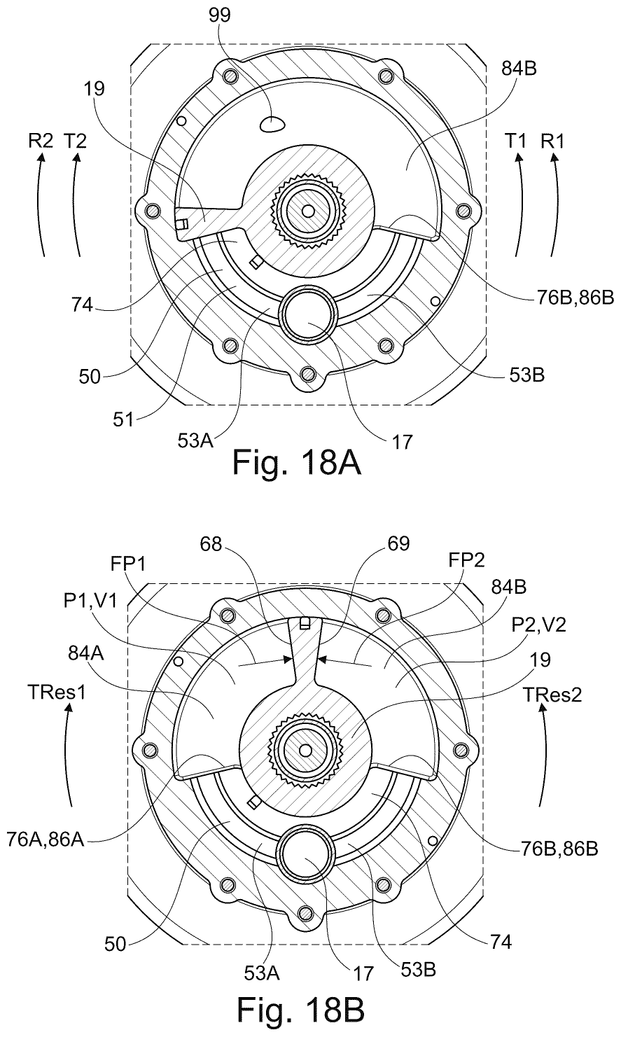

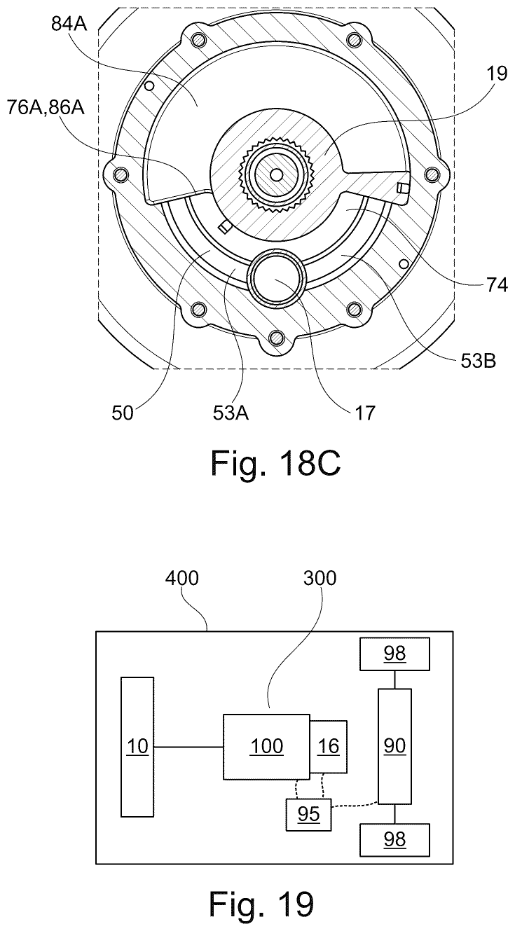

FIG. 3 shows a cross-sectional view of the handwheel actuator 100 and the handwheel 10 taken from FIG. 1. FIG. 4 shows an exploded perspective view of the handwheel actuator 100. FIG. 5 shows an exploded perspective view of a portion of the handwheel actuator 100. FIGS. 6A and 6B show perspective views of the portion of the handwheel actuator 100 shown in FIG. 5. FIG. 7 shows an exploded perspective view of an example embodiment of a rotary damper 19 and corresponding seals. FIG. 8 shows an exploded perspective view of an example embodiment of a housing 24 and sealing components of the housing. FIGS. 9A and 9B show perspective views of the housing 24 and sealing components. FIG. 10A shows an exploded perspective view of an example embodiment of a rear cover 34 and a rolling element bearing 35. FIG. 10B shows a perspective view of the rolling element bearing 35 installed within the rear cover 34. FIG. 11 shows a perspective view of an example embodiment of an electronic fluid control valve (EFCV) 17 for the handwheel actuator 100. FIG. 12A shows a cross-sectional view of the EFCV 17 taken from FIG. 11 with the EFCV 17 in a first flow state. FIG. 12B shows a cross-sectional view of the EFCV 17 taken from FIG. 11 with the EFCV 17 in a second flow state. FIG. 12C shows a cross-sectional view of the EFCV 17 taken from FIG. 11 with the EFCV 17 in a third flow state. FIG. 13 shows a perspective view of an example embodiment of a planetary carrier 30 of the handwheel actuator 100. FIG. 14 shows an exploded perspective view of the planetary carrier 30. FIG. 15 shows an exploded perspective view of an example embodiment of an input shaft 44 and first and second driver pins 43A, 43B for the handwheel actuator 100. FIG. 16 shows an exploded perspective view of an example embodiment of a front cover 46 together with a rolling element bearing 47. FIG. 17 shows an end view of the handwheel actuator 100 without the front cover 46 installed. FIGS. 18A-18C show cross-sectional views of the handwheel actuator 100 taken from FIG. 1 with the rotary damper 19 in three different rotational positions. FIG. 19 shows a schematic representation of a drive-by-wire steering system 300 of a vehicle 400. The following should be read in light of FIGS. 1-19.

Turning to FIG. 19, the drive-by-wire steering system 300 includes the handwheel 10, the handwheel actuator 100, a handwheel sensor 16, an electronic control unit (ECU) 95, a steering actuator 90, and wheels 98. The ECU 95 communicates electronically with the handwheel actuator 100, the handwheel sensor 16, and the steering actuator 90. That is, the ECU 95 is configured to either receive an electronic signal or provide an electronic signal to any of these components. Furthermore, the ECU 95, as known within vehicle applications, can control the drive-by-wire steering system 300 so that an operator or driver input to the handwheel 10 is translated to a steering action of the wheels 98 via the electronically controlled steering actuator 90. Given that there is no mechanical connection between the handwheel 10 and the wheels 98, the handwheel actuator 100 is configured to provide force feedback to the driver or operator during a steering process of the vehicle 400.

The handwheel actuator 100 uses the rotary damper 19 to provide a selectively variable torque characteristic at the handwheel 10. This characteristic may be tuned using the EFCV 17, which can be commanded to various positions depending on an amount of torque resistance required or selected for a particular driving condition. A reduction in the form of a planetary gearset 82 is used to reduce the required rotary travel of the rotary damper 19, allowing the handwheel actuator 100 to fit in a small package space. Return springs 6 are utilized to return the handwheel 10 to a neutral position when the driver input is removed.

The handwheel 10, which can also be referred to as a steering wheel or a driver interface, is attached to an input shaft 44 which transmits an input torque applied to the handwheel 10 to a sun gear 45 of the input shaft 44. The sun gear 45 can be integral with the input shaft 44 or a separate component that is fixed to the input shaft 44. Torque is transmitted from the sun gear 45 to the planetary carrier 30, which rotates at a slower speed than the input shaft 44. Any suitable speed ratio between the input shaft 44 and the planetary carrier 30 can be utilized. Larger speed ratios equate to a smaller angular displacement of the rotary damper 19 which can be useful for reducing packaging space. Planet gears 38 arranged within the planetary carrier 30 engage a grounded ring gear 25 integrated within the housing 24. The term “grounded” is meant to indicate that that the housing 24 is attached to the vehicle 400 and is therefore held in a stationary position. The ring gear 25 could also be a separate component that is fixed to the housing 24. A rear carrier 37 of the planetary carrier 30 is attached to the rotary damper 19 via a torsional interface 54 which facilitates rotation of the rotary damper 19 within the housing 24. Measurables of the input rotation of the input shaft 44, such as angular position and speed, are captured by the handwheel sensor 16 that includes a rotary position target 9 and a sensor board 11. This information can be sent to the ECU 95 to adjust rotational resistance (or a resistant torque) applied to the input shaft 44 via the rotary damper 19 and the EFCV 17.

Any suitable reduction can be utilized other than the planetary gearset that is described and shown in the figures. For example, a parallel axis gear pair could also be utilized.

Turning to FIGS. 1 and 15, when an input torque Tl is applied to the handwheel 10 to rotate it in a first rotational direction R1 about a rotational axis AX1, a first resistant torque TRes1 can be applied to the input shaft 44 via the rotary damper 19. Likewise, when an input torque T2 is applied to the handwheel 10 to rotate it in a second rotational direction R2, a second resistant torque TRes2 can be applied to the input shaft 44 via the rotary damper 19. The attainment of the first and second resistant torques TRes1, TRes2 will now be described.

Turning to FIG. 7, the rotary damper 19 includes a hub 55 and vane 56 that extends radially outwardly from the hub 55. The hub 55 includes a through-bore 57 formed with a hub spline 58. Turning to FIGS. 13 and 14, the rear carrier 37 of the planetary carrier 30 includes a plate portion 66 and an axial protrusion 48 that extends from the plate portion 66. A carrier spline 49 is formed on a radial outer surface of the axial protrusion 48. The carrier spline 49 is fixed to the hub spline 58 of the rotary damper 19 and together form the torsional interface 54 so that the planetary carrier 30 (or rear carrier 37 thereof) and the rotary damper 19 rotate in unison. The axial protrusion 48 of the rear carrier 37 includes a bore 59 through which the input shaft 44 extends. Furthermore, the input shaft 44 extends entirely through the planetary carrier 30.

The rotary damper includes three seals. A radial seal 20 is springably disposed (by a spring 22) within a groove 78 arranged at a radial outer extent of the vane 56; and, axial seals 21 are springably disposed (by springs 23) within axial face grooves 79 of the hub 55. The springs 22, 23 could also be eliminated from the respective radial and axial seals.

Turning to FIGS. 7-9A and 18A-18C, the rotary damper 19 is sealingly disposed within a fluid well 70 formed within a rear portion 71 of the housing 24. The fluid well 70 is defined by a radial outer wall 72, an axial surface 73, and an arc-shaped boss 74 that extends axially outward (rearward) from the axial surface 73. The radial seal 20 of the rotary damper 19 slidably engages the radial outer wall 72 of the fluid well 70 as the rotary damper 19 rotates. The axial seals 21 of the rotary damper 19 also slidably engage the axial surface 73 of the fluid well 70 and an inner axial surface 65 of the rear cover 34. Furthermore, the axial seals 21 are axially compressed via attachment of the rear cover 34 to the rear portion 71 of the housing 24 via fasteners 16. An additional radial seal 26 that is disposed (via optional spring 27) within an axial groove 75 of an inner radial wall of the arc-shaped boss 74 provides sealing of the hub 55 as it rotates within the fluid well 70 of the housing 24. The arc-shaped boss 74, which could be described as a curved boss, extends around the rotational axis AX1.

The front cover 46 and rear cover 34 can be considered as components of the housing 24 of the handwheel actuator 100. The rear cover 34 is sealably attached to the rear portion 71 of the housing 24 via an O-ring 28. The rotary damper 19 forms a first fluid chamber 84A and a second fluid chamber 84B with the housing 24. It could also be stated that the rotary damper 19 forms the first fluid chamber 84A and the second fluid chamber 84B with the fluid well 70. In particular, a first side 68 of the vane 56 of the rotary damper 19 forms the first fluid chamber 84A, and a second side 69 of the vane 56 of the rotary damper 19 forms the second fluid chamber 84B. The first and second fluid chambers 84A, 84B could be described as being curved, annular, ring-shaped or arc shaped.

In an example embodiment, when the input torque T1 is applied to the handwheel 10 to rotate it in the first rotational direction R1, the first fluid chamber 84A is compressed and the second fluid chamber 84B is expanded. When this occurs, compression of the first fluid chamber 84A increases a fluid pressure P1 within the first fluid chamber 84A, and expansion of the second fluid chamber 84B decreases a fluid pressure P2 within the second fluid chamber 84B. The resultant pressure differential (P1-P2) between the two chambers can cause the fluid to flow from the first fluid chamber 84A to the second fluid chamber 84B via the metered fluid passage 50. Similarly, when the input torque T2 is applied to the handwheel 10 to rotate it in the second rotational direction R2, the second fluid chamber 84B is compressed and the first fluid chamber 84A is expanded. When this occurs, compression of the second fluid chamber 84B increases the fluid pressure P2 within the second fluid chamber 84B, and expansion of the first fluid chamber 84A decreases the fluid pressure P2 within the first fluid chamber 84A. The resultant pressure differential (P2-P1) between the two chambers can cause the fluid to flow from the second fluid chamber 84B to the first fluid chamber 84A.

Three of many possible angular positions of the rotary damper 19 are shown in FIGS. 18A-18C. In a first angular position shown in FIG. 18A, the first side 68 of the vane 56 of the rotary damper 19 abuts or engages with a first end 76A of the arc-shaped boss 74, defining a first rotational limit of the rotary damper 19 in the first rotational direction R1. In a second angular position shown in FIG. 18B, the rotary damper 19 resides in a middle position of the fluid well 70 such that a first volume VI of the first fluid chamber 84A is equal to a second volume V2 of the second fluid chamber 84B. In an example embodiment, the second angular position corresponds to a non-turning position of the handwheel 10 and/or the wheels 98. In a third angular position shown in FIG. 18C, the second side 69 of the vane 56 of the rotary damper 19 abuts or engages with a second end 76B of the arc-shaped boss 74, defining a second rotational limit of the rotary damper 19 in the second rotational direction R2. The first and second ends 76A, 76B of the arc-shaped boss define respective first and second rotational end stops 86A, 86B for the rotary damper 19.

The first and second fluid chambers 84A, 84B can be filled with any suitable fluid. Fluid 99 is exchanged between the first and second fluid chambers 84A, 84B via a metered fluid passage 50 that extends from the first end 76A of the arc-shaped boss 74 to the second end 76B of the arc-shaped boss 74. Thus, the metered fluid passage 50 fluidly connects the first fluid chamber 84A to the second fluid chamber 84B. The metered fluid passage 50 is defined by a curved or arc-shaped groove 51 arranged on an annular top surface 83 of the arc-shaped boss 74 (see FIG. 8). Rotation of the handwheel 10 displaces fluid from one fluid chamber to the other fluid chamber via an open state of the metered fluid passage 50. Therefore, fluid that is exchanged between the first and second fluid chambers 84A, 84B moves about the rotational axis AX1 via the arc-shaped groove 51.

When the input torque Tl is applied to the handwheel 10 to rotate it in the first rotational direction R1, the rotary damper 19 displaces fluid from the first fluid chamber 84A to the second fluid chamber 84B during an open state of the metered fluid passage 50. Likewise, when the input torque T2 is applied to the handwheel 10 to rotate it in the second rotational direction R2, the rotary damper 19 displaces fluid from the second fluid chamber 84B to the first fluid chamber 84A during an open state of the metered fluid passage 50. In an example embodiment, when the rotary damper 19 rotates in the first rotational direction R1, the volume V1 of the first fluid chamber 84A decreases and the volume V2 in the second fluid chamber increases; and when the rotary rotates in the second direction, the volume V1 of the first fluid chamber 84A increases and the volume V2 in the second fluid chamber decreases. When the rotary damper 19 is engaged with the first rotational end stop 86A as shown in FIG. 18A, the volume V1 of the first fluid chamber 84A is zero and a volume V2 of the second fluid chamber 84B is at a maximum. When the rotary damper 19 is engaged with the second rotational end stop 86B as shown in FIG. 18C, the volume V2 of the second fluid chamber 84B is zero and the volume V1 of the first fluid chamber 84A is at a maximum.

A variable or selective rotational resistance can be provided to the handwheel 10 via the rotary damper 19 as it pushes fluid out of one fluid chamber and into another fluid chamber via the metered fluid passage 50. This variable rotational resistance occurs due to a controlled variability of a flow area of the metered fluid passage 50, accomplished via the EFCV 17.

The EFCV 17 is mounted to the rear cover 34 via a fastener 18. In an example embodiment, the EFCV 17 can be a proportional solenoid valve, as known in the field of electronic valves. The EFCV 17 includes an electric coil 60 that, when energized via an electrical plug 63, actuates an armature 62. The armature 62 is integrally formed with a gate 64 so that the armature 62 and gate 64 move together within a housing 67. A nose 87 of the housing 67 extends through an opening 85 of the rear cover 34. The nose 87 is inserted within a blind bore 52 of the arc-shaped boss 74 such that the blind bore 52 intersects or interrupts the arc-shaped groove 51, defining a first channel 53A or passage, and a second channel 53B or passage. The nose 87 includes circumferential through-openings 13 that fluidly connect the arc-shaped groove 51 to the gate 64. The gate 64 and its longitudinal position, as controlled by the electric coil 60 and armature 62, define a variable flow area of the metered fluid passage 50.

Turning to FIGS. 12A-12C, three longitudinal positions of the gate 64 are shown that define three flow areas of the metered fluid passage 50. In FIG. 12A, the electric coil 60 is de-energized and a spring 61 moves the armature 62 and gate 64 to a closed position such that no fluid can pass through EFCV 17, defining a “normally closed” characteristic of the EFCV 17. No fluid can be exchanged between the first and second fluid chambers 84A, 84B when the gate is closed, defining a “zero” flow area. In an example embodiment, the closed position EFCV 17 can be utilized to lock the handwheel 10 in any rotational position so that it cannot be rotated.

Turning to FIG. 12B, the electric coil 60 is energized so that the armature 62 and gate 64 are moved slightly to the right, resulting in a flow gap G1 which defines a flow area FAI through which the fluid of the metered fluid passage 50 can flow and pass through the EFCV 17. Therefore, when the rotary damper 19 is rotated in the first rotational direction R1, fluid is displaced from (or exits from) the first fluid chamber 84A and flows, in succession: through the first channel 53A, through the EFCV 17 in a first direction DI via the flow gap G1, through the second channel 53B, and to the second fluid chamber 84B. Furthermore, when the rotary damper 19 is rotated in the second rotational direction R2, fluid is displaced from (or exits from) the second fluid chamber 84B and flows, in succession: through the second channel 53B, through the EFCV 17 in a second direction D2 via the flow gap G1, through the first channel 53A, and to the first fluid chamber 84A.

Turning to FIG. 12C, the electric coil 60 is energized so that the armature 62 and gate 64 are moved further to the right, resulting in a flow gap G2 which defines a flow area FA2 through which the fluid of the metered fluid passage 50 can flow and pass through the EFCV 17. Therefore, when the rotary damper 19 is rotated in the first rotational direction R1, fluid is displaced from (or exits from) the first fluid chamber 84A and flows, in succession: through the first channel 53A, through the EFCV 17 via the flow gap G2, through the second channel 53B, and to the second fluid chamber 84B. Furthermore, when the rotary damper 19 is rotated in the second rotational direction R2, fluid is displaced from (or exits from) the second fluid chamber 84B and flows, in succession: through the second channel 53B, through the EFCV 17 via the flow gap G2, through the first channel 53A, and to the first fluid chamber 84A. Given that the flow gap G2 and the corresponding flow area FA2 of FIG. 12C is greater than the flow gap G1 and corresponding flow area FAI of FIG. 12B, a fluid flow resistance provided by the EFCV 17 of FIG. 12C is less than a fluid flow resistance provided by the EFCV 17 of FIG. 12B. A lower flow resistance translates to a lower resistant torque provided by the rotary damper 19 to the input shaft 44, and thus, to the handwheel 10. Therefore, a flow gap of the EFCV 17 can be varied to achieve a desired resistant torque that is applied to the handwheel 10.

The previously described longitudinal positions of the EFCV 17 were described for a “normally closed” valve configuration. In an example embodiment, the EFCV 17 is configured to be “normally open”, meaning that when the electric coil is de-energized, the armature is springably moved to an open gate position. The longitudinal positions shown in FIGS. 12A-12C could be accommodated with such a normally open valve configuration.

A variable and selective resistant torque can be applied to the input shaft 44 when the rotary damper 19 rotates about the rotational axis AX1. The variability and selectiveness are accomplished via the metered fluid passage 50, or more specifically, the EFCV 17 that controls a fluid flow resistance or fluid flow rate through the metered fluid passage 50. The resistant torque is a product of a fluid pressure that acts on the vane 56 of the rotary damper 19. For example, when the handwheel 10 is rotated in the first rotational direction R1 via the input torque T1, the first fluid chamber 84A decreases in volume and compresses the fluid contained within the first fluid chamber 84A. This rotary motion can generate a pressure P1 within the first fluid chamber 84A that acts on the first side 68 of the vane 56 (see FIG. 18B). This pressure P1, or the magnitude thereof, can be controlled by the EFCV 17. A decreasing opening magnitude of the gate 64 of the EFCV 17 will yield: i) a decreasing fluid flow rate through the metered fluid passage 50, and ii) an increasing flow resistance of the metered fluid passage 50. For a constant input torque T1, a small opening magnitude of the gate 64 will generate a larger pressure in the first fluid chamber 84A than a pressure that results from large opening magnitude of the gate 64. The pressure P1 acts on an area A1 of the first side 68 of the vane 56 to produce a force FP1 on the vane 56. The force FP1 equates to the first resistant torque TRes1 that is applied to the rotary damper 19 and input shaft 44, which translates back to the handwheel 10. Similarly, when the handwheel 10 is rotated in the second rotational direction R2 via the input torque T2, a pressure P2 generated within the second fluid chamber 84B acts on the second side 69 of the vane 56 to produce a force FP2 on the vane 56. The force FP2 equates to the second resistant torque TRes2 that is applied to the rotary damper 19 and input shaft 44, which translates back to the handwheel 10.

In an example embodiment, a resistant torque provided to the handwheel 10 by the rotary damper 19 and the metered fluid passage 50 can be adjusted with software of the ECU 95. In a further aspect, the software can vary the resistant torque based on handwheel speed and/or vehicle speed or any other suitable parameter or variable.

The EFCV 17 can be that of any suitable electronically controlled valve. In an example embodiment, the EFCV 17 is an on/off type of solenoid valve that opens the gate 64 to a given longitudinal position each time it is energized. In a further aspect, the EFCV 17 can be configured to receive a pulse-width modulated (PWM) digital signal, known in the field of electronically controlled valves, from the ECU 95. A frequency and duration of opening and closing of the gate 64 can be varied to control a fluid flow resistance or fluid flow rate of the metered fluid passage 50. This variation is accomplished by energization or de-energization of the electric coil 60, as controlled by the ECU 95.

Regardless of the valve type or control method, the EFCV 17 selectively varies the fluid flow resistance of the metered fluid passage 50. The smaller the commanded opening magnitude of the EFCV 17, the higher the fluid flow resistance.

The metered fluid passage 50 could be described as a “flow path” that extends between the first and second fluid chambers 84A, 84B, and the EFCV 17 selectively controls: i) a size of the flow path (or size of an opening thereof), or ii) a magnitude of obstructing or blocking of the flow path via the gate 64.

In an example embodiment, a total volume of the fluid contained within the first and second fluid chambers 84A, 84B is held constant through various rotational positions of the rotary damper 19. Therefore, when the rotary damper 19 is angularly displaced within the housing 24, a volume of fluid that is removed from the reduced-volume fluid chamber is equal to a volume of fluid that is added to the increased-volume fluid chamber, assuming that the metered fluid passage 50 is in an open state and the first and second fluid chambers and metered fluid passage 50 are full of fluid.

In addition to the active control provided by the EFCV 17, the metered fluid passage 50 can inherently produce a velocity-dependent flow resistance due to an orifice-like flow condition of the EFCV 17. Therefore, for any commanded longitudinal position of the gate 64, a faster rotation of the handwheel 10 will result in a greater resistant torque provided by the metered fluid passage 50.

Turning to FIGS. 3, 4, and 17, the handwheel actuator 100 includes first and second springs 6A, 6B acting as return springs for the handwheel 10. In a drive-by-wire steering system, since there is no mechanical connection between the wheels 98 and the handwheel 10, there is no inherent tendency of the wheels 98 to move to a straight or non-turning position when an input torque is removed from the handwheel 10. The springs 6A are configured to return the handwheel 10 to a home position, which can be defined by either: i) a straight or non-turning position of the handwheel 10 and wheels 98, or ii) a position in which the net spring force acting on the input shaft 44 is zero. In an example embodiment, the rotary vane (middle) position shown in FIG. 18B can correspond to the home position of the handwheel 10 and wheels 98. Thus, the first and second springs 6A, 6B respectively apply opposing return torques TR1, TR2 that can overcome at least a fluid flow resistance of the metered fluid passage 50 (EFCV 17 is open) and an inherent friction of the planetary carrier 30 to move the input shaft 44 to an angular position at which the opposing return torques TR1, TR2 are equal. In an alternative embodiment, a detent feature arranged within the handwheel actuator 100 is utilized to position the input shaft 44 or rotary damper 19 at the home position.

Turning to FIG. 17, the first and second springs 6A, 6B are shown with respective first and second legs 7A, 7B that engage respective first and second spring openings 88A, 88B arranged on an axial face 81 of the front portion 80 of the housing 24. The first and second springs 6A, 6B include respective first and second hooks 89A, 89B that wrap around respective first and second driver pins 43A, 43B attached to the sun gear 45 of the input shaft 44.

In an example embodiment, when the input shaft 44 is rotated in the first rotational direction R1 via an input torque Tl applied to the handwheel 10: i) the first spring 6A is wound via a rotation of the sun gear 45 and corresponding first driver pin 43A, inducing a return torque TRI on the input shaft 44; and ii) the second spring 6B is not wound (and thus no return torque is induced) and the second driver pin 43B slidably moves along an arc-shaped path within a curved portion 91B of the second hook 89B. Upon removal of the input torque T1 from the handwheel 10, the return torque TR1 can return (rotate) the input shaft 44 and handwheel 10 to a rotational position that corresponds with a non-turning position at which a zero net return torque is acting on the input shaft 44. Once in the non-turning position, the second driver pin 43B will re-engage the second hook of the second spring 6B. Similarly, when the input shaft 44 is rotated in the second rotational direction R2 via a torque T2 applied to the handwheel 10: i) the second spring 6B is wound via a rotation of the sun gear 45 and corresponding second driver pin 43B, inducing a return torque TR2 on the input shaft 44; and ii) the first spring 6A is not wound (and thus no return torque is induced) and the first driver pin 43A slidably moves along an arc-shaped path within a curved portion 91A the first hook 89A. Upon removal of the torque T2 from the handwheel 10, the return torque TR2 can return (rotate) the input shaft 44 and handwheel 10 to a rotational position that corresponds with a non-turning position at which a zero net return torque is acting on the input shaft 44. Once in the non-turning position, the first driver pin 43A will re-engage the first hook 89A of the first spring 6A. Any suitable force generators can be used in place of the first and second springs 6A, 6B shown and described herein. In an example embodiment, the first and second springs 6A, 6B can be torsion springs. In a further aspect, the torsion springs can provide a constant torque (or nearly so) or a variable torque throughout their winding and unwinding motions.

In an example embodiment, the first and second fluid chambers 84A, 84B and the metered fluid passage 50 define a variable resistance closed fluid system. The term “closed fluid system” is meant so signify that, during operation of the handwheel actuator 100: i) fluid is not supplied to the closed fluid system from a source outside of the handwheel actuator 100 (such as, but not limited to, a pump), and ii) fluid is not exited from the closed fluid system to a reservoir or component outside of the handwheel actuator 100. Stated otherwise, the closed fluid system is self-contained such that all of its fluid, and the exchange thereof, remains within the handwheel actuator 100. In addition, the first and second fluid chambers 84A, 84B and the metered fluid passage 50 are all completely enclosed within the housing 24.

Turning to FIGS. 13 and 14, the planetary carrier 30, which together with the sun gear 45 form the planetary gearset 82, includes a front carrier 36 that is joined together with a rear carrier 37. Various methods such as laser welding could be utilized for joining or attaching the front carrier 36 to the rear carrier 37. The front and rear carriers 36, 37 can be manufactured via a stamping process or any other suitable manufacturing means. The front and rear carriers 36, 37 house the planet gears 38, planet pins 39, bearings 40, and washers 41. A thrust washer 42 may be added to help axially retain the planetary carrier 30 within the handwheel actuator 100. The gears are depicted within the figures as straight cut, but can be helical for noise reduction purposes.

The following describes an example embodiment of an assembly of the handwheel actuator 100. Turning to FIG. 4, a washer 2 and the planetary carrier 30 are installed into the housing 24. The input shaft 44, assembled with the first and second driver pins 43A, 43B is inserted through the planetary carrier 30 and the housing 24, and the springs 6A, 6B are installed on the respective first and second driver pins 43A, 43B and within the respective first and second spring openings 88A, 88B of the housing 24. The front cover 46, assembled with the rolling element bearing 47, is attached via fasteners 8 to the housing 24.

Turning to FIGS. 5-6B, the rotary damper 19 is pressed onto the carrier spline 49 of the planetary carrier 30, and the housing 24 is closed by attaching the rear cover 34 (assembled with the rolling element bearing 35) to the housing 24 via fasteners 5. The EFCV 17 is fixed to the rear cover 34 with the fastener 18. The rolling element bearings 47, 35 housed within the respective front and rear covers 46, 34, are configured to rotatably support the input shaft 44. Any suitable fit can be applied between the rolling element bearings 47, 35, and: i) the input shaft 44, and ii) the respective front and rear covers 46, 34 including, but not limited to, a press-fit (interference fit), a transition fit, and a slip fit, as known in the field of rolling element bearings. Different fits may affect an assembly sequence of the rolling element bearings 47, 35; for example, the rolling element bearings 47, 35 could be installed on input shaft 44 before the front and rear covers 46, 34 are fastened to the housing 24.

Turning to FIGS. 3 and 4, the target 9 of the handwheel sensor 16 is secured to the input shaft 44 with a fastener 33. The sensor board 11 of the handwheel sensor 16 is secured to the rear cover 34 with fasteners 12.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A handwheel actuator for a steering system, the handwheel actuator comprising:
a housing;
a shaft disposed within the housing, the shaft configured to be rotatably driven by a handwheel;
a rotary damper rotatably driven by the shaft about a rotational axis, the rotary damper and the housing forming a first fluid chamber and a second fluid chamber; and
rotation of the rotary damper in a first direction is configured to displace a fluid from the first fluid chamber to the second fluid chamber so as to apply a rotational resistance to the shaft; and
rotation of the rotary damper in a second direction is configured to displace a fluid from the second fluid chamber to the first fluid chamber so as to apply a rotational resistance to the shaft.

2. The handwheel actuator of claim 1, further comprising a metered fluid passage configured to fluidly connect the first fluid chamber to the second fluid chamber.

3. The handwheel actuator of claim 2, wherein the metered fluid passage is arranged in the housing.

4. The handwheel actuator of claim 2, wherein the metered fluid passage is electronically metered.

5. The handwheel actuator of claim 2, wherein a fluid flow resistance of the metered fluid passage is controlled via an electronic fluid control valve.

6. The handwheel actuator of claim 1, wherein the rotational resistance can be varied based on vehicle speed.

7. The handwheel actuator of claim 1, wherein the at least one of the first fluid chamber and the second fluid chamber is ring-shaped.

8. The handwheel actuator of claim 1, wherein rotary movement of the rotary damper is configured to move the fluid about the rotational axis.

9. The handwheel actuator of claim 1, wherein the shaft is configured to be rotatably driven by the handwheel about the rotational axis.

10. The handwheel actuator of claim 1, wherein the first fluid chamber is sealingly separated from the second fluid chamber via the rotary damper.

11. The handwheel actuator of claim 1, wherein a rotational range of the shaft is greater than a rotational range of the rotary damper.

12. The handwheel actuator of claim 1, further comprising a reduction arranged within the housing.

13. The handwheel actuator of claim 12, wherein the reduction is a planetary gearset.

14. The handwheel actuator of claim 12, wherein the reduction is arranged between the shaft and the rotary damper such that the shaft drives the reduction and the reduction drives the rotary damper.

15. A handwheel actuator for a steering system, the handwheel actuator comprising:
a housing;
a rotary damper configured to be rotatably driven by a handwheel, the rotary damper and the housing defining a first fluid chamber and a second fluid chamber;
a metered fluid passage arranged to fluidly connect the first fluid chamber and the second fluid chamber; and
the first fluid chamber, the second fluid chamber, and the metered fluid passage define a variable resistance closed fluid system arranged within the housing; and
rotation of the rotary damper is configured to displace a fluid within the variable resistance closed fluid system so as to apply a rotational resistance to the rotary damper.

16. The handwheel actuator of claim 15, wherein the first fluid chamber is defined by a first side of the rotary damper and the housing, and the second fluid chamber is defined by a second side of the rotary damper and the housing.

17. The handwheel actuator of claim 16, further comprising a shaft disposed within the housing, the shaft drivably connected to the rotary damper.

18. A handwheel actuator for a steering system, the handwheel actuator comprising:
a housing;
a rotary damper configured to be rotatably driven by a handwheel, the rotary damper and the housing defining a first fluid chamber and a second fluid chamber; and
rotation of the rotary damper is configured to exchange a fluid between the first fluid chamber and the second fluid chamber so as to apply a rotational resistance to the rotary damper.

19. The handwheel actuator of claim 18, further comprising a metered fluid passage arranged between the first fluid chamber and the second fluid chamber, and a flow area of the metered fluid passage is electronically variable so as to vary the rotational resistance.

20. The handwheel actuator of claim 19, further comprising at least one spring arranged within the housing, the at least one spring configured to return the handwheel to a non-turning position.
